(19) United States
(12) Patent Application Publication
(10) Pub. No.: US 2007/0241897 A1
(43) Pub. Date: Oct. 18, 2007

(54) System and Method for Monitoring the Cargo Space of a Transporation Device

(75) Inventor: Juergen Knuepfer, Gera (DE)

Correspondence Address: DARBY & DARBY P.C., P.O. BOX 770, Church Street Station, New York, NY, 10008-0770, US

(73) Assignee: HerthGmbh & Co. KG, Heusenstamm (DE)

(21) Appl. No.: 10/596,392

(22) PCT Filed: Dec. 7, 2004
(86) PCT No.: PCT/EP04/13909

§ 371 Date: Feb. 27, 2007

(30) Foreign Application Priority Data
Dec. 10, 2003 (DE) 20319131.5

(51) Int. Cl. B60R 25/10; G08B 13/14

(52) U.S. Cl. 340/568.1; 340/426.1; 340/426.16; 340/426.19; 340/429

(57) ABSTRACT

A monitoring system for the cargo space of a transporting device such as a goods-carrying vehicle, an aircraft or a container, including a control unit, to which a characteristic value for the actual state of motion of the transporting device can be fed and which, on the data input-side, is connected to a number of motion sensors and, on the data output-side, to a number of image recording units.

The invention relates to a monitoring system for the cargo space of a transportation means such as, for example, a truck, an airplane or a container. It also relates to a method for monitoring the cargo space of such a transportation means.

Damage and losses due to theft are on the rise whenever valuable goods or products such as, for instance, electronic equipment, computer systems, cellular phones, memory chips or other high-tech products are transported. Particularly during the transportation phase in which relatively large quantities of such valuable goods are handled together in appropriate transportation means such as trucks, airplanes, shipping containers and the like, a relatively high loss rate due to theft can be observed since, in contrast to storage of the equipment in permanent buildings, only limited security is possible employing locking mechanisms and the like.

Monitoring systems for the cargo space of trucks can be used in order to counter such losses due to theft, for example, during the transportation of valuable goods on trucks. With such monitoring systems, the loading door of the truck is normally sealed or kept locked and is additionally monitored for unauthorized opening. It is then possible to ascertain an unscheduled opening of the loading door, which indicates that a theft has been attempted. In addition or as an alternative, monitoring cameras can be used for the cargo space with which, analogously to video monitoring of, for example, public buildings, the cargo space of the transportation means is continuously monitored, and the image data thus acquired is stored, for instance, on magnetic storage media and kept on hand for archiving.

Monitoring systems of the above-mentioned type, however, have the drawback that, for example, monitoring the loading door alone is not sufficient to detect unauthorized access to the cargo space, for instance, through damage to the side walls of the transportation means, especially side tarpaulins of a truck. Thus, with such systems, unauthorized access to the cargo space can take place without this being detected by such a monitoring system. On the other hand, the use of monitoring cameras has the drawback that they can be relatively sensitive to impact and weather conditions, especially in conjunction with the image-recording systems, and consequently are only somewhat suitable for sturdy long-term use, also under adverse ambient conditions. Moreover, the recording and archiving of the image data in the form of magnetic storage media such as video cassettes makes it more difficult to systematically evaluate the image material since fairly irrelevant information and hence fairly large volumes of information are stored in the process.

Therefore, in order to secure valuable goods, complex and thus costly procedures can be necessary in which, for example, barcodes or transponder security systems for goods are used or else specially trained personnel conduct random inspections or even physically accompany the goods.

Consequently, the invention is based on the objective of creating a monitoring system for the cargo space of a transportation means that, on the one hand, has a sturdy design and is thus especially well-suited for reliable use, even under adverse ambient conditions and that, on the other hand, ensures an especially high reliability in terms of monitoring the cargo space. Moreover, a method that is especially suitable for monitoring the cargo space of a transportation means is to be put forward.

As far as the monitoring system is concerned, this objective is achieved according to the invention with a control unit that can receive a characteristic value for the current state of motion of the transportation means, and that is connected to a number of motion detectors on the data input side and to a number of image-recording devices on the data output side.

The invention is based on the consideration that an especially high level of security and reliability can be achieved with actual cargo space monitoring using optical monitoring means, especially image-recording devices, in contrast to merely monitoring the loading doors of the transportation means. In order to achieve especially great sturdiness—particularly in terms of the requisite data storage and data archiving—with such a basic configuration of the monitoring system using optical monitoring means, the monitoring system should be systematically configured for a demand-driven recording of image data of the cargo space. Particularly in terms of storing the recorded image data, a special simplification and hence an especially sturdy design of the monitoring system can be achieved in that the storage and archiving of unneeded data—for example, for the periods of time in which no unauthorized access to the load surface exists—are avoided in the first place. In order to achieve this, the recording of monitoring images should be limited to those situations in which a need for recording has been recognized, so that consistently, the only data that is stored is data that is employed as being relevant for a later evaluation.

In order to make this possible, the image-recording devices, such as, for example, monitoring cameras, that have been provided as the monitoring equipment should fundamentally be operated in a so-called “stand-by mode” and are only fully activated if a need for monitoring is recognized. For this purpose, a control unit is provided that systematically actuates and activates the image-recording devices in such situations. In order to recognize the need for recording, the control unit should be supplied with suitable data on the input side. On the one hand, in order to take into account the fact that theft normally occurs only when the transportation means is at a standstill but not, for instance, while a truck is being driven or during a flight, the control unit should be supplied with data about the state of motion of the transportation means. On the other hand, a movement ascertained in the cargo space that is to be monitored should be taken as the criterion for triggering the recording of image data. The control unit can preferably be configured in such a way that the image-recording devices are only activated when the transportation means is at a standstill and movement is registered in the cargo space.

Instead of supplying a characteristic value—which is normally ascertained automatically—about the state of motion of the transportation means, it is also possible for the monitoring system to be activated—for instance, manually—when the transportation means is standing still or when another situation is present that might be theft-relevant. This can especially be the case if the transportation means is a container, particularly a shipping container.

The motion detector can be, for example, commercially available motion detectors that can ascertain especially human movements in the cargo space. As an alternative or additionally, the notion detectors advantageously comprise a number of acceleration sensors that can supply acceleration data for the cargo space particularly in three dimensions and direction-dependently. Such acceleration sensors can be configured to be so sensitive that, for example, the vibrations and position changes on the load surface generated by movements of persons on the load surface of a truck can be registered. In an especially advantageous embodiment, such acceleration sensors can also be used to ascertain a shift of the goods during transportation so that, in such a constellation, the monitoring system can be used to monitor the goods in terms of damage during transportation, for example, due to extreme vibration, shock stress and the like.

In order to allow a data transfer and/or a later external evaluation of the recorded image data, the image-recording device or each image-recording device is advantageously connected to a memory module. In an especially advantageous embodiment, the memory module in question is configured for digital data storage, preferably a configuration as a multi-media card being provided. These can be especially digital memory cards such as those that can also be used, for instance, in digital cameras. On the one hand, such memory cards can be used within a relatively wide temperature range from −25° C. to +85° C. [−13° F. to 185° F.] so that a reliable operation of the monitoring system including the storage of the recorded image data is possible, even under relatively adverse ambient conditions. Moreover, such memory cards are particularly resistant to the shock and vibration stresses that occur within the scope of the operation of trucks. Furthermore, they are largely maintenance-free and stand out for their small space requirements as well as relatively low production or purchase costs. It is precisely the demand-driven recording of monitoring images achieved with the monitoring system that leads to a marked reduction in the requisite storage capacities, so that the advantages of such memory cards can be utilized without the drawback that the storage capacity would be too small for purposes of recording.

Advantageously, characteristic values for authorized loading and/or unloading positions are stored in the memory module of the monitoring system. In this manner, an additional criterion that can be taken into account is the demand-driven activation of the monitoring system in order to determine whether the transportation means is currently in a position in which loading and/or unloading procedures can be expected, so that here, no activation is necessary, even if a movement is ascertained.

A very suitable demand-driven utilization of existing storage capacities and a very systematic concentration of the image recording on situations truly considered to be relevant can be achieved in that, after having been activated by the control unit, the image-recording device or each image-recording device advantageously records a predefinable number of images, after which the image-recording device in question is once again deactivated. Thus, the control unit starts the image recording once a relevant situation has been recognized on the basis of the determined input data, for example, due to movement on the load surface. However, after the image recording has started, it does not continue indefinitely but rather is limited to a predefinable data volume. Here, for example, a predefined period of observation or else a predefined number of individual images to be recorded can be specified as the limit for the image recording. Once this limit has been reached, the image-recording device in question is deactivated, a process in which it can deactivate itself autonomously or else it can be deactivated by the central control unit.

The fundamental configuration of the monitoring system allows a very compact and as-needed archiving of relevant image data that facilitates, among other things, a later evaluation of the data material received. Moreover, in order to contribute to protecting the goods against theft, also in the sense of providing active security measures, an especially advantageous embodiment of the monitoring system is equipped with means for systematically triggering an alarm if a theft attempt is detected. Using the configuration of the monitoring system for systematically initiating certain measures after the detection of a theft attempt, for example, on the basis of the motion detector, this information can be used not only to trigger the demand-driven image recording but also to generate alarm messages and the like. For this purpose, the control unit of the monitoring system is advantageously connected on the data output side to a transmitter for wireless data transmission via which, for example, alarm messages can be sent if necessary. In particular, a cellular module can be provided (GSM module or, for example, satellite-aided via INMAR-SAT), with which, for example, a message can be sent to a cellular telephone of the driver or to a central station if movement on the load surface is detected.

In another advantageous embodiment, the monitoring system is equipped with a GPS (Global Positioning System) unit so that additionally, data can be provided about the current position of the transportation means, for example, the truck. This position information can be stored together with the recorded image data so that—optionally with the additional storage of the date and time—a precise spatial association can be made with the recorded image data. Furthermore, however, the position data can also be transmitted together with the alarm message or with other data to external recipients such as, for instance, a central station, so as to allow a real-time tracking of the occurrences taking place on the load surface and, at the same time, a determination of the position. Moreover, as a result, an external unit such as, for example, a logistics center, can at any time request the position and the operating status of the transportation means and can externally trigger the transmission of images. Especially advantageously, the data thus acquired can be used in combination with characteristic values stored in the memory unit pertaining to positions where loading and/or unloading procedures are scheduled and where movements in the transportation means are to be expected anyway.

Advantageously, the control unit of the monitoring system is connected on the data input side with an information system on the transportation means. In the case of a truck, this can especially be an information system about the current driving status such as, for example, a speedometer. Thus, in an especially simple manner, the current state of motion of the vehicle can be ascertained and the information pertaining to this can be further processed appropriately. In particular, it can be provided that the image-recording devices or other measures are only activated when no driving speed is registered, that is to say, when the vehicle is at a standstill, in which case theft would actually be conceivable. As an alternative or additionally, the control unit can also be connected to the ignition lock on the truck so that alarm or detection procedures are only initiated if the ignition lock has not been actuated and consequently the driver is not in the vehicle.

In order to even further expand the functionality of the monitoring system, in another advantageous embodiment, the control unit is fitted with a number of interfaces that, as needed, serve to connect other functional components such as, for example, barcode scanners or article security systems. The information that can be obtained in this manner can also be stored electronically or digitally. Thus, in particular, goods identification systems for systematically tracking the goods can be installed, for example, during loading or unloading.

The monitoring system is suitable for use in different kinds of transportation means in which theft of the goods might have to be considered as a possibility such as, for example, airplanes, shipping containers or other containers and the like. In an especially advantageous embodiment, however, the monitoring system is configured for use in trucks.

Regarding the method, the above-mentioned objective is achieved in that a number of image-recording devices are activated as a function of the current state of motion of the transportation means and of movement ascertained in the cargo space. This ensures that images are only recorded in situations that have been recognized as being relevant, so that the data processing and archiving are kept especially simple.

Advantageously, the movement in the cargo space is ascertained on the basis of acceleration data about the transportation means. Here, in particular, acceleration sensors can be used that can be configured so as to be so sensitive that, when the transportation means is at a standstill, even careful movements of persons on the load surface can be recognized on the basis of vibrations generated on the load surface.

The detected image data is advantageously stored digitally, especially on a multi-media card.

Advantageously, after the image-recording device or each image-recording device has been activated, it records a predefinable number of images and is subsequently once again deactivated. The system then goes into a power-saving monitoring mode so that the number of recorded images is reduced to the absolutely minimum number required, thus concurrently alleviating the power supply, especially the vehicle battery. In particular, the monitoring system can be configured in such a way that the power consumption in such a “stand-by mode” is only about 40 mA.

In order to additionally secure the goods, after image-recording devices have been activated, advantageously a warning message is sent to a transmitter associated with the monitoring system. In this manner, a cellular message can be generated for the driver or for a central station. Moreover, advantageously, after image-recording devices have been activated, the position of the transportation means is additionally determined and, if applicable, concurrently archived or transmitted.

The advantages achieved with the invention lie especially in the fact that the cargo space can be monitored especially reliably, thanks to the demand-driven activation of the image-recording devices, along with only a small need for storage or archiving. Especially in combination with the envisaged deactivation of the image-recording devices after a predefined monitoring time or after the recording of a predefined maximum number of monitoring images, the storage capacity needed can be kept especially low so that it is possible to employ particularly sturdy and flexible digital storage technology without a loss of relevant information. Hence, the monitoring system can be operated without requiring a great deal of resources which, in the monitoring mode or “stand-by mode”, can save considerable power and resources. Only when needed, that is to say, when unauthorized movement is detected on the load surface, is the system fully activated, which then calls for correspondingly greater power consumption.

An embodiment of the invention is explained in greater detail with reference to a drawing, in which the following is shown:

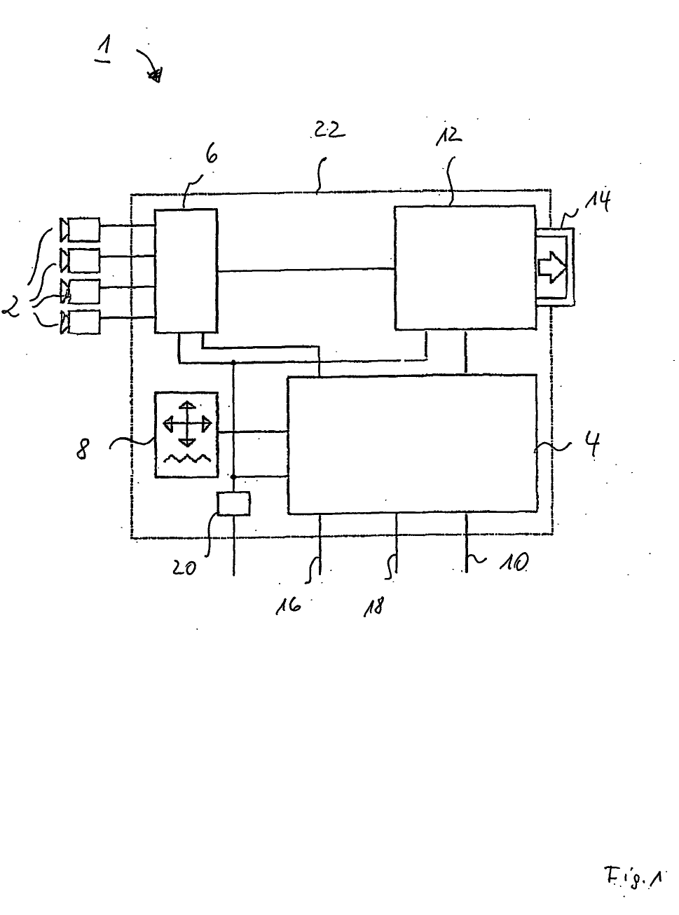

FIG. 1 a schematic depiction of a monitoring system, and

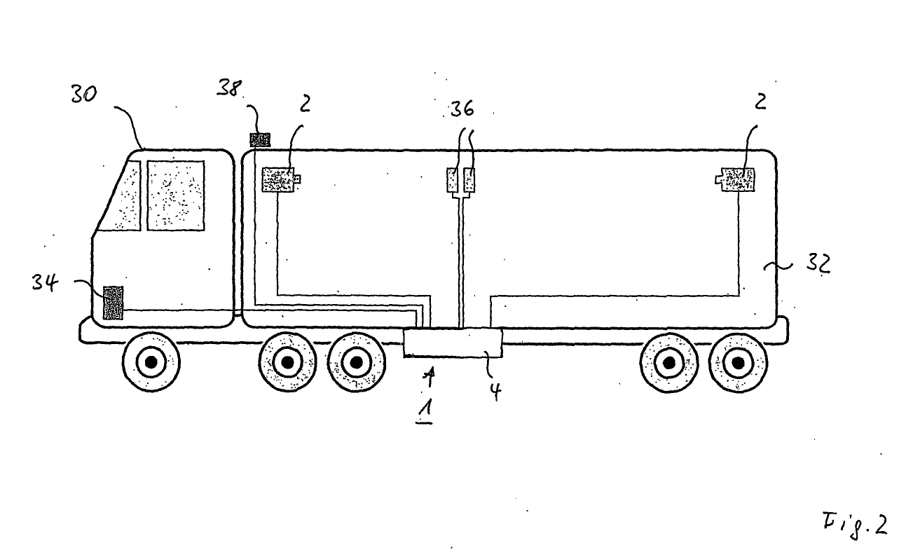

FIG. 2 a truck equipped with a monitoring system according to FIG. 1. The same parts are designated with the same reference numerals in the figures.

The monitoring system 1 according to FIG. 1 is intended to secure the cargo space of a transportation means against theft of the goods held there. The transportation means can be especially a truck, an airplane or a container such as, for example, a shipping container, whereby the monitoring system 1 is also suitable for use in other transportation means where, for example, theft is a concern because of the valuable goods being transported. The monitoring system 1 is configured essentially for an optical monitoring of the cargo space and comprises a number of image-recording devices 2 that can be configured especially as rapid video cameras. The image-recording devices 2 can create an optical documentation of events on the cargo space that is to be monitored, so that persons and the like can be subsequently identified on the basis of the data acquired in this manner for a later evaluation.

The monitoring system 1 is configured for high operational reliability, along with an especially low need for storage capacity for the optical information obtained. For this purpose, it is provided that the image-recording devices 2 of the monitoring system 1 do not continuously record image data in the active mode but rather, that the image data recording is triggered on-demand only when this is considered necessary. To this end, the monitoring system 1 has a control unit 4 that is connected to the image-recording devices 2 on the data output side via an interposed multiplexer 6 or mixer. Here, the control unit 4 is configured in such a way that it only activates the image-recording devices 2 in case of need, so that they then start recording the image data.

In order to enable the demand-driven activation of the image-recording devices 2, as provided in this configuration, the control unit 4 is connected on the data input side with a number of motion detectors. In the embodiment, a number of acceleration sensors 8 are provided as motion detectors that are configured for a relatively sensitive data acquisition and that supply current acceleration data in all three dimensions (x, y and z values). When the acceleration sensors 8 are hard-wired to the load surface to be monitored, the acceleration sensors 8 can also recognize vibrations caused by persons present on the load surface, so that the presence of persons can be ascertained on the basis of the acceleration sensors 8. As an alternative or additionally, however, the presence of persons in the cargo space to be monitored can be recognized by conventional motion detectors.

Moreover, the demand-driven activation of the image-recording devices 2 makes use of the fact that the presence of persons on the load surface to be monitored should be deemed to be unauthorized only in certain cases. In particular, it can be assumed that theft can be ruled out during the movement of the transportation means, since as a rule, attempted theft only takes place when the transportation means is standing still or parked. In order to be able to take this into consideration with the demand-driven activation of the image-recording devices 2, the control unit 4 can be connected on the data input side via an interface 10 to an information system on the transportation means, for example, to an electronic system of an airplane or truck. Consequently, via the interface 10, the control unit 4 can receive a characteristic value For the current state of motion of the transportation means, which can constitute, for example, a speedometer pulse coming from the vehicle.

In order to be able to suitably provide the recorded image data for purposes of later evaluation or archiving, the image-recording devices 2 and the control unit 4 are connected to a memory unit 12 comprising a memory module 14 that is suitable for digital data storage such as those that can also be used in digital cameras. This memory card can be removed from the memory unit 12 and can be further processed in other suitable peripheral devices such as a personal computer, whereby, for example, a data transfer for archiving or else a digital image enlargement and the like can be performed. In order to prevent manipulation, the recordings are suitably coded in the memory module 14 so that an accurate evaluation is ensured. Moreover, the information on the memory module can be compressed by means of an appropriate method such as JPEG 2000 in order to keep the required storage capacity especially small.

In addition, the control unit 4 is also equipped with an interface 16 for connecting external sensors and with another interface 18 for connecting other functional units such as a transmitter for wireless data transfer, a GPS receiver and the like.

The control unit 4, the memory unit 12 and the image-recording devices 2, via the associated multiplexer 6, are also connected to a shared power supply 20 which, in turn, is connected on the input side to the power supply of the transportation means, especially the on-board electronics of a vehicle. The control unit 4, the multiplexer 6, the acceleration sensors 8 and the memory unit 12 are arranged inside a shared housing 22. Since the essential functional components can be configured using integrated chip technology, the outer dimensions of the housing 22 can be kept relatively compact.

As can be seen in FIG. 2, the monitoring system 1 can be integrated especially into a truck 30 and can serve to monitor its cargo space 32. The image-recording devices 2 are mounted inside the cargo space in a suitable manner, especially on one end, so that complete spatial monitoring of the interior of the cargo space 32 is possible. The control unit 4 is connected on the input side to the on-board electronics 34 of the truck 30 so that especially the speedometer pulse and/or information as to whether the ignition is switched on can also be taken into account when the information is being processed. Moreover, the control unit 4 in the embodiment according to FIG. 2 is connected to additional sensors 36 that, on the one hand, can provide additional information about the current state of motion of the cargo space 32 but, on the other hand, can also supply additional information about the ambient pressure, ambient temperature and the like that allow a readjustment of measured values acquired elsewhere. Furthermore, in the embodiment according to FIG. 2, the control unit 4 is connected to an antenna system 38 for GPS and cellular telephony.

The monitoring system 1 is essentially intended to ascertain by means of the acceleration sensors 8 or other motion detectors whether there are movements of the cargo space 32 or in the cargo space 32 when the transportation means in question, especially the truck 30, is at a standstill. If such a relevant movement is recognized, for example, through shock and/or vibration, the image-recording devices 2 are activated by the control unit 4. After their activation, the image-recording devices 2 record a predefinable number of images and are subsequently once again deactivated. As a result, the recorded images and the data that was also recorded are reduced to an especially small data volume, a process in which it is also ensured that only relevant data is forwarded for purposes of further evaluation. In this manner, with high security, an especially small storage requirement is ensured.

As soon as the movements on the load surface 32 that have been ascertained as being relevant allow the conclusion that loading, unloading (either authorized or unauthorized due to theft) or else damage or destruction of the goods have taken place, a predefined number of images are recorded by the image-recording devices 2, which are subsequently stored on the memory module 14 in digital form. This procedure can also be triggered by external sensors such as, for example, by infrared motion detectors, door contacts and the like. The date and time of the event are automatically superimposed onto and stored along with the stored images so that a subsequent evaluation and allocation of the recorded data are greatly simplified.

Via the GPS systems that might have been additionally connected, the precise location of the event can be stored, together with the images. Moreover, this makes it possible to distinguish between permissible loading or unloading positions, which can be stored, for instance, in a central unit, and impermissible positions, thus automatically triggering an alarm via a cellular unit (GSM modem, UMTS-modem, satellite-aided INMARSAT and the like) that might likewise be connected. As a result, the determined location is transmitted. Furthermore, the position and the operating status of the truck 30 can be queried at any time by an external unit such as, for example, a logistics center, and the transmission of images can be triggered. In addition, images of transportation means that are joined to each other can be transmitted to a master transport unit (for example, from a trailer to the tractor via a video transmitter). The connection of goods identification systems (barcode scanners, electronic article security systems and the like) can be provided in order to track the goods during loading or unloading. This information is also stored in the electronic data memory unit. Moreover, physical parameters such as temperature and humidity can be monitored and stored by means of suitable connections with sensors.

The set-up of the monitoring system 1 allows an especially responsive demand-driven activation of the image-recording devices 2 and thus a mode of operation that does not require a great deal of resources. When the truck 30 is at a standstill and nevertheless the appertaining sensors detect a movement, the image-recording devices 2 are activated and a number of images to be specified by the user are recorded on the memory module 14. After the recording, the monitoring system 1 switches to a stand-by mode in which power can be saved, until the next time a movement is detected in the cargo space 32. The power consumption in such a stand-by mode amounts to only about 40 mA.

Consequently, the monitoring system 1 allows an uninterrupted monitoring of the cargo space 32 with subsequent archiving of the images determined as being relevant. An appropriately sensitive configuration of the motion detectors or acceleration sensors 8 also allows the recording of the most minute movements in the cargo space 32. The selected components ensure good resistance to temperature and a wide operating range of possible ambient temperatures from −25° C. to +85° C. [−13° F. to 185° F.]. Moreover, the monitoring system 1 is not sensitive to vibration or shock stresses, and in addition, any manipulation of the recorded images is ruled out.

As an alternative, the monitoring system 1 can also be configured for monitoring a container such as, for example, a shipping container. Here, it is especially taken into account that such applications can entail a relatively long period of time during which the system is disconnected from the power source so that a low power consumption of the monitoring system is of special importance. For such an application, the functional components of the monitoring system are advantageously arranged in a housing 22 that is sealed against ocean water or salt water.

### LIST OF REFERENCE NUMERALS

1 monitoring system
2 image-recording device
4 control unit
6 multiplexer
8 acceleration sensors
10 interface
12 memory unit
14 memory module
16, 18 interfaces
20 power supply
30 truck
32 cargo space
34 on-board electronics
36 sensors
38 antenna system

1-17. (canceled)

18: A monitoring system for the cargo space of a transportation means, the monitoring system comprising:
a control unit configured to can receive a characteristic value for a current state of motion of the transportation means;
a plurality of motion detectors connected to a data input side of the control unit; and
a plurality of image-recording devices connected to a data output side of the control unit.

19: The monitoring system as recited in claim 18, wherein the plurality of motion detectors include a plurality of acceleration sensors.

20: The monitoring system as recited in claim 18, further comprising a memory module, and wherein at least one of the image-recording devices is connected to the memory module.

21: The monitoring system as recited in claim 20, wherein at least one of the memory modules is configured for digital data storage.

22: The monitoring system as recited in claim 21, wherein the at least memory module includes a multi-media card.

23: The monitoring system as recited in claim 20, wherein the memory module stores characteristic values for permissible loading and/or unloading positions.

24: The monitoring system as recited in claim 18, wherein at least one of the image-recording devices is configured to, upon activation by the control unit, record a predefinable number of images and subsequently deactivate itself autonomously.

25: The monitoring system as recited in claim 18, further comprising a transmitter for wireless data transmission connected to the data output side of the control unit.

26: The monitoring system as recited in claim 18, further comprising a GPS receiver connected to the control unit.

27: The monitoring system as recited in claim 18, wherein the transportation means includes and information system and wherein the control unit is connected to the information system.

28: The monitoring system as recited in claim 18, further comprising a plurality of interfaces for connecting other functional components and wherein the control unit is connected to the plurality of interfaces.

29: A vehicle having a cargo space that is provided with a monitoring system as recited in claim 20

30: A method for monitoring a cargo space of a transportation means, the method comprising:
ascertaining a movement in the cargo space; and
activating a plurality of image-recording devices as a function of a current state of motion of the transportation means and of the movement in the cargo space.

31: The method as recited in claim 30, wherein the ascertaining of the movement in the cargo space is performed based on acceleration data of the transportation means.

32: The method as recited in claim 30, further comprising digitally storing detected image data produced by the plurality of image recording devices.

33: The method as recited in claim 32, wherein the detected image data is stored digitally on a multi-media card.

34: The method as recited in claim 30, further comprising, after the activating, recording a predefinable number of images using at least one of the image-recording devices and subsequently deactivating the plurality of image-recording devices.

35: The method as recited in claim 30, further comprising, after the activating, sending a warning message to a transmitter.

36: The method as recited in claim 30, further comprising, after the activating, determining a position of the transportation means.
